(19) United States
(12) Patent Application Publication
(10) Pub. No.: US 2016/0123224 A1
(43) Pub. Date: May 5, 2016

(54) SPRING LOADED PISTONS

(71) Applicant: UMM AL-QURA UNIVERSITY, Makkah (SA)

(72) Inventor: Saleh Abdullah Saleh AL SALAMEH, Al Rass (SA)

(73) Assignee: UMM AL-QURA UNIVERSITY, Makkah (SA)

(21) Appl. No.: 14/414,180

(22) PCT Filed: Nov. 4, 2014
(86) PCT No.: PCT/IB14/02340

§ 371 Date: Jan. 12, 2015

(51) Int. Cl. F02B 75/32

(52) U.S. Cl. CPC F02B 75/32

(57) ABSTRACT

Embodiments include a spring loaded piston in an internal combustion engine. In certain embodiments, the internal combustion engine may include a two stroke, one cylinder piston engine having first springs connecting between a piston and a cylinder head and second springs connecting between the piston and the base of the piston cylinder. The first springs are relatively compressed when the crankshaft is at top dead center while the second springs are relatively relaxed when the crankshaft is at top dead center and vice versa at when the crankshaft is at bottom dead center. During the power/intake stroke, some of the fuel's energy is delivered to the crankshaft and some is used to compress the second springs. The stored energy in the second springs is delivered to the crankshaft during the exhaust/compression stroke while the second springs return to their relatively relaxed condition and vice versa for the first springs.

### BACKGROUND

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

A standard four-stroke, piston engine utilizes intake, compression, power, and exhaust strokes, and delivers power to the crankshaft during the power stroke of each cylinder. Therefore, in a one cylinder, four-stroke engine, power is delivered to the crankshaft only one fourth of the time. In most typical, two-cylinder, four-stroke engines, the cycles of each cylinder are phased apart so that the power strokes of each cylinder occur at different times. As a result, power is delivered to the crankshaft only half of the time. In a conventional one cylinder, two-stroke engine, power is delivered to the crankshaft only half the time, during the power/intake stroke. Engine vibration results from this sporadic power delivery in the three engine types described above as well as high frequency fluctuations in vehicle speed, acceleration during the power strokes, and deceleration during the other strokes due to the load friction, and other loss factors.

One conventional remedy is to use a heavy crankshaft which acts as a flywheel or a flywheel itself, which, by its inertia, tends to keep the crankshaft speed constant. However, there are at least three problems with this system. First, the weight of the crankshaft or flywheel causes excess gas consumption, and makes the vehicle less manageable if it is otherwise light weight such as a motorcycle, motorized bicycle, or lawn mower. Second, the flywheel/crankshaft is not totally effective in maintaining engine speed. Third, it does not prevent the relatively low frequency engine vibration at the frequency of the crankshaft rotation in a two cylinder, four-stroke engine or in a one cylinder, two-stroke engine due to the sporadic power delivery to the crankshaft.

Another remedy is to build the engine with as many cylinders as strokes, and sequence the power strokes from each cylinder to provide one power stroke during each stroke. This system provides a more uniform power delivery to the crankshaft and so, less, low frequency vibrations and fluctuations in speed, but it is costly, heavy, and gas consumptive.

### SUMMARY

Embodiments include an internal combustion (IC) engine having at least one piston cylinder having a top portion and a base portion. The IC engine also includes at least one valve configured to introduce fuel into the at least one piston cylinder and at least one fuel igniter configured to ignite the introduced fuel. The IC engine further includes at leave one valve configured to exhaust burnt gases from the at least one piston cylinder and a piston disposed within the at least one piston cylinder. The IC engine also includes a crankshaft coupled to the piston via a connecting rod. The connecting rod is pivotally connected to the piston and the crankshaft. The IC engine further includes a first one or more springs configured to store energy received from the at least one piston and burnt gases during the power/intake stroke of the at least one piston, and to deliver a portion of the stored energy to the crankshaft during the compression/exhaust stroke of the at least one piston to drive the crankshaft in its existing direction of rotation.

Embodiments also include an IC engine having at least one piston cylinder including at least one valve configured to introduce fuel into the at least one piston cylinder, at least one fuel igniter configured to ignite the introduced fuel and at leave one valve configured to exhaust burnt gases from the at least one piston cylinder, and a first piston disposed within the at least one piston cylinder. The IC engine includes a first crankshaft coupled to the first piston via a first connecting rod. The first connecting rod is pivotally connected to the first piston and the first crankshaft. The IC engine also includes at least one dedicated independent piston cylinder having a top portion and a base portion. The at least one dedicated independent piston cylinder is configured such that no internal combustion occurs therein. The IC engine further includes a second piston disposed within the at least one dedicated independent piston cylinder. The second piston is coupled to a second crankshaft via a second connecting rod. The second connecting rod is pivotally connected to the second piston and the second crankshaft. The IC engine also includes a first one or more springs configured to store energy received from the second piston during the outward movement of the second piston, and to deliver a portion of the stored energy to the second crankshaft during the inward movement of the second piston to drive the second crankshaft in its existing direction of rotation.

Embodiments further include an IC engine having means for housing at least one piston, where the means for housing includes means for introducing fuel into the means for containing, means for igniting the introduced fuel, and means for exhausting the burnt gases. The IC engine also includes means for reciprocating the at least one piston. The IC engine further includes a first resilient means for storing energy received from the at least one piston during the outward movement of the at least one piston, and for delivering a portion of the stored energy to the means for reciprocating during the inward movement of the at least one piston to drive the means for reciprocating in its existing direction of rotation. The IC engine also includes a second resilient means for storing energy received from the at least one piston and burnt gases during the power/intake stroke of the at least one piston, and for delivering a portion of the stored energy to the means for reciprocating during the compression/exhaust stroke of the at least one piston to drive the means for reciprocating in its existing direction of rotation.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIGS. 1A and 1B are schematic views of a spring loaded piston configuration in an internal combustion engine according to a first embodiment of the disclosure.

FIGS. 2A to 2F are schematic views of a spring loaded piston configuration in an internal combustion engine according to a second embodiment of the disclosure.

FIGS. 3A to 3G are schematic views of a spring loaded piston configuration in an internal combustion engine according to a third embodiment of the disclosure.

FIGS. 4A and 4B are schematic views of a spring loaded piston configuration in an internal combustion engine according to a fourth embodiment of the disclosure.

### DETAILED DESCRIPTION OF THE EMBODIMENTS

Referring now to the drawings, wherein like reference numerals designate identical or corresponding parts throughout the several views.

A spring retains its inherent energy when it is compressed, and thus this property can be utilized and applied to increase the efficiency of an internal combustion (IC) engine by assisting in the power/intake stroke and/or the combustion/exhaust stroke of the IC engine. In some embodiments, the efficiency of the IC engine can be improved by placing a set of springs inside a piston cylinder, disposed on the face of a piston and/or disposed on the base of the piston. These springs may be formed as spiral (helical) springs or coiled springs. These springs may also be configured as compression springs, designed to resist being compressed.

In some embodiments, disposing springs within the piston cylinder may provide a smooth running IC engine with fewer low frequency vibrations and fewer vehicle speed fluctuations. In certain embodiments, these springs may make the IC engine run more smoothly with only a lightweight crankshaft being used. In some embodiments this smooth running IC engine may use fewer cylinders than its number of strokes per cycle. In other words, for example, a four-stroke IC engine may use less than four cylinders to operate, thereby, saving in overall construction and parts.

In view of these embodiments and advantages, one, two, or more springs may be connected between the piston and the crankshaft side of each piston cylinder and/or between the piston and some other point. Also, one, two or more springs may be connected between the piston and a top portion of the piston cylinder.

These springs may be compressed or stretched as the case may be to store energy released by the combustion gases during the power stroke of the respective piston cylinders. Some of the energy released by the combustion gases may also work to drive the crankshaft during the power stroke. Then, during the exhaust stroke, the springs may deliver their stored energy to the crankshaft. Also, during the intake stroke, energy may be stored in the springs and this energy may be delivered to the crankshaft during the next compression stroke. As a result, for example, a two cylinder, four-stroke engine, phased so that when one cylinder is in the power stroke, the other cylinder is in the intake stroke, can provide net energy delivered to the crankshaft during each stroke. Alternatively, for example, in a one cylinder, two-stroke engine, net energy may be delivered to the crankshaft during both strokes, that is, the power/intake stroke and the exhaust/compression stroke. As a result, low frequency vibrations in the engine and low frequency fluctuations in speed may be reduced, and the engine may run smoother.

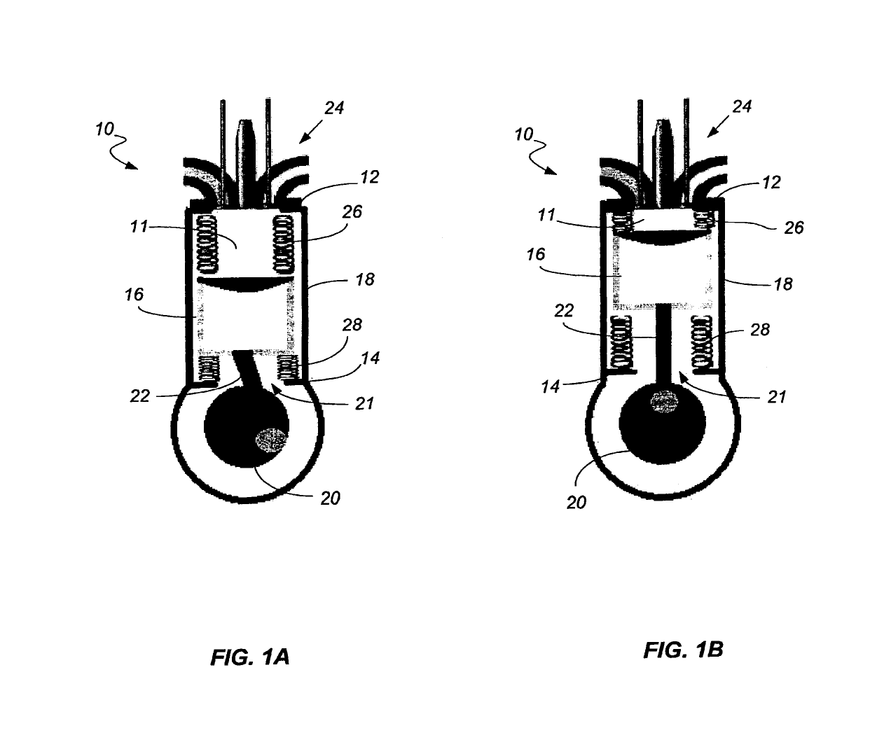

FIGS. 1A and 1B are schematic views of a spring loaded piston configuration in an internal combustion (IC) engine 10 according to a first embodiment of the disclosure. The view of IC engine 10 is partially shown, however, it should be noted that additional piston cylinders may be included, for example, two-cylinder, four-cylinder or more engine types. In FIG. 1A, an IC engine 10 may include a piston cylinder 18 having a top portion 12 disposed adjacent an intake/exhaust valve 24, a combustion chamber 11, a base portion 14 disposed above a crankshaft 20, a piston 16 having a top portion and a base portion, a first set of springs 26, a second set of springs 28, and a connecting rod 22 configured to pivotally connect the base portion of piston 16 to the crankshaft 20 for reciprocation. The first set of springs 26 are attached to the top portion 12 and the second set of springs 28 are attached to the base portion 14. The first set of springs 26 are further disposed within the piston cylinder 18 and attached to the top portion of piston 16. The first set of springs 26 are also disposed in a combustion chamber 11. The second set of springs 28 are also disposed within the piston cylinder 18 and attached to the base portion of piston 16, adjacent the connecting rod 22. In certain embodiments, the first set of springs 26 may include at least a pair of springs and the bottom set of springs 28 may include at least a pair of springs, as shown in FIGS. 1A and 1B, for example. Two springs are used instead of one in order to balance the force upon the piston 16. If only one spring were used, for example, from either set of springs 26 or 28, it would apply a torque to the piston 16 since neither spring would be aligned along the axis of piston 16. In other words, this two-spring per cylinder system example would still store and deliver energy, and so, function in the same way as the sets of springs 26, 28 per cylinder system, but the two-spring per cylinder system would cause more friction on the piston edges. FIG. 1A shows piston 16 in a power stroke after combustion, where the second set of springs 28 are in a relatively compressed state and thereby store part of the energy of the power stroke. Further, the first set of springs 26 are in a released state and thereby release part of the energy from the compression stroke as shown in FIG. 1B to assist in the power stroke, thereafter. Thus, FIG. 1B shows piston 16 in a compression stroke before combustion at top dead center (TDC), where the second set of springs 28 release their stored energy from the power stroke to assist in compression, while the first set of springs 26 are compressed and store some of the compression energy to be used during the power stroke, and the cycle proceeds.

Thus, the second set of springs 28 may be configured to assist with the exhaust/compression stroke by releasing their stored energy received during the power/intake stroke spring compression at BDC of the piston 16, while, the first set of springs 26 may be configured to assist with the power/intake stroke by releasing their stored energy received during the compression/exhaust compression at TDC of the piston 16.

Both the first set of springs 26 and second set of springs 28 are configured to withstand engine stress and strain of the reciprocating piston 16 and the heat of combustion within chamber 11. For instance, the set of springs 26 and/or 28 may comprise steel alloys or nickel/titanium alloys, such as Nitinol or the like. Nitinol is a family of specialty nickel/titanium alloys which exhibit unique shape memory and super-elastic characteristics. This class of materials may be formed into a spring, bent or twisted into a different shape, and then easily returned to their original shape.

FIGS. 1A and 1B also show piston cylinder 18 may be configured with base portion 14 formed to engage and attach to set of springs 28. Further, base portion 14 may be configured to have a connecting rod opening 21 to allow reciprocal motion for the connecting rod 22 during cycling of piston 16. Thus, opening 21 is configured to provide the back and forth motion of the connecting rod 22 results from its revolution about the axis of crankshaft 20.

The top and vertical sides of piston cylinder 18 are standard except the sides of certain embodiments may be elongated to better accommodate sets of springs 26, 28. Piston 16, connecting rod 22, and crankshaft 20 are typical of conventional piston engines. By way of example, in cylinder 18 of the four-stroke engine (at 10), fuel enters the combustion chamber 11 of cylinder 18 via valves at 24. Then, the gaseous fuel is compressed in the standard way by the upward movement of crankshaft 20, connecting rod 22, and piston 16. Then, the fuel is ignited in the usual way in the combustion chamber 11 by a spark plug (not shown). The burning fuel expands and pushes the piston 16 downward, according to the orientation of FIG. 1A, although the cylinder 18 can be oriented in any direction and still work, and connecting rod 22 also proceeds downward rotating crankshaft 20. This power stroke drives crankshaft 20, and ultimately the load.

However, unlike conventional four stroke IC engines, all of the work produced when the fuel burns or combusts does not go towards driving the crankshaft 20. Instead, approximately one fourth of that work, at moderate loads, goes toward compressing the second set of springs 28, so that approximately as much work is delivered to the crankshaft 20 as is stored together in springs 28 and the energy of the springs 28 being delivered to the crankshaft 20 during the subsequent exhaust/compression stroke. Springs 28 may be relayed or only slightly compressed or stretched when crankshaft 20 is at top dead center (TDC) the end of the compression stroke, and are significantly compressed when the crank is at bottom dead center (BDC) and vice versa with respect to springs 26 during the same cycling of IC engine 10.

For example, if operating a two cylinder, four-stroke engine, cranks (not shown) of the two cylinders may point in the same direction meaning that when one cylinder is at TDC the other is at TDC. Also, both cranks drive the same crankshaft 20. The cam and fuel intake/exhaust valves 24 may be set as such that when one cylinder is in the power stroke, while the other is in the intake stroke. As a result, when each cylinder 18 delivers energy to crankshaft 20 by its power stroke, the springs 28 in the two cylinders are compressing and storing energy. Then, during the next stroke, the exhaust stroke for one cylinder and the compression stroke for the other cylinder, both pairs of springs 26, 28 deliver their energy to the crankshaft 20. This two stroke process is repeated as the two cylinders swap roles. Note that intake/exhaust valves 24 such as valves exhaust the burnt gases during the exhaust stroke from combustion chamber 11 and valves intake the fuel-air mixture during the intake stroke to combustion chamber 11.

In this example, to obtain the most constant energy delivery to the crankshaft 20, each set of springs 26, 28 after one power/intake stroke should be configured to store approximately one half the energy delivered by one piston during one power stroke to the crankshaft 20 during average loads. In other words, both sets of springs 26, 28 store energy during the same two intervals, one cylinder's power stroke (approximately BDC) and the other cylinder's compression stroke (approximately TDC) and vice versa, so, as much net energy goes to the crankshaft 20 as into both sets of springs 26, 28 during these two intervals. Then, both sets of springs 26, 28 deliver their energy to the crankshaft 20 during the same two intervals, one cylinder's exhaust stroke and the other's compression stroke and vice versa, so, the same amount of energy will be delivered to the crankshaft 20 during these two intervals as was delivered during the prior two. Thus, the sets of springs 26, 28 work together to deliver approximately the same amount of energy to the crankshaft 20 during the exhaust/compression strokes as is delivered by the piston 16 and hot gas to the crankshaft 20 during each power/intake stroke. Note that the set of springs 26, 28 store the same amount of energy during the power/intake strokes regardless of the load or the amount of fuel that is burned at any time, so, their stiffness should be configured or predetermined such as to equalize their energy storage with the energy delivered to the crankshaft 20 by one piston at an average or usual load.

Because of the energy delivery to the crankshaft 20 by the sets of springs 26, 28 during the non-power stroke intervals, there are only short periods when no energy is being input to the crankshaft 20, when at about TDC and BDC. As a result, the “coast” durations of crankshaft 20 are much less than in a conventional two cylinder, four-stroke engine when the crankshaft must coast half of the time. Therefore, as mentioned previously, a much lighter crankshaft 20 can be used than in a conventional two cylinder, four-stroke engine. Also, the vibrations and fluctuations in engine speed are reduced and have a higher frequency; as a result, they are less noticeable and less offensive to the operator. In fact, this example two cylinder, four-stroke engine with the sets of springs 26, 28 may be configured to run, at certain loads, as smooth as a conventional, four cylinder, four-stroke engine, thereby reducing costs.

Alternatively, in an example embodiment, the engine 10 may have two strokes per cycle, and may have one piston cylinder 18. It should be noted that a one cylinder, two-stroke engine has less of a problem than a one cylinder, four-stroke engine because the two-stroke engine has a power stroke during half of the cycle instead of one fourth of the cycle, as in the four-stroke engine. The piston cylinder 18 is typical of two-stroke engines with a conventional piston, cam, fuel intake valve, exhaust valve, connecting rod, crank, and crankshaft, although all these parts are not shown. However, the springs, such as, sets of springs 26 and 28 situated between the top and base of the piston 16 and the cylinder head (at 12) and base portion 14 of the piston cylinder 18 may be configured as above to assist during each cycle of engine 10. Also, the height of the piston cylinder 18 may be greater to allow more length to the sets of springs 26, 28, so the added length may make it easier to find a spring which can store the necessary energy to assist in each engine stroke.

In a manner analogous to that described above for the engine 10 to be configured as a four-stroke engine, power is delivered to the crankshaft 20 and stored in the set of springs 26 during the power/intake stroke, and power is delivered by the springs 28 to the crankshaft 20 during the exhaust/compression stroke; the set of springs 28 are relatively relaxed or only slightly compressed or stretched when the crankshaft 20 is at or near TDC and the set of springs 28 were most compressed when the crankshaft 20 was at or near BDC and vice versa for the set of springs 26 (see. FIGS. 1A and 1B). Also, the sets of springs 26, 28 may be configured to have a stiffness (generally, k=F/X Hooke's law) such that at moderate loads, approximately the same amount of energy is delivered to the crankshaft 20 during the power/intake stroke as is stored in the sets of springs 26, 28 during the same stroke. Thus, during the next exhaust/compression stroke, a like amount of energy is delivered to the crankshaft 20. As a result, a one cylinder, two-stroke engine may run about as smoothly as a conventional two cylinder, two-stroke engine at a certain load corresponding to where the energy into the crankshaft 20 during the power/intake stroke equals the energy into the crankshaft 20 from the sets of springs 26, 28 during the exhaust/compression stroke.

In another variation of the first embodiment, the structure of FIGS. 1A and 1B may represent a single cylinder unit of a one cylinder, four-stroke engine, which operates as does the first embodiment except, during the power stroke, the springs 28 store approximately the same amount of energy as is delivered to crankshaft 20 by the piston 16 and burning gases under moderate load or a usual load. This variation does not provide as constant of an energy delivery to the crankshaft 20 as does the two cylinder, four-stroke engine or the one cylinder, two-stroke engine because, during the intake stroke, energy is actually drawn from the crankshaft 20 to compress the springs 28; during the other three strokes, energy is delivered to the crankshaft 20. But, this variation may lessen the low frequency vibration as compared to a standard one cylinder, four-stroke engine operating at the same power output.

Some conventional fastener, such as bolting or welding, may be configured to secure the sets of springs 26, 28 to piston 16 and to top portion 12 and base portion 14, as well as the other springs in subsequent embodiments to their points of attachment. Connecting rod 22 attaches to piston 16 by conventional pivoting connectors, and is rotatably mounted to crankshaft 20.

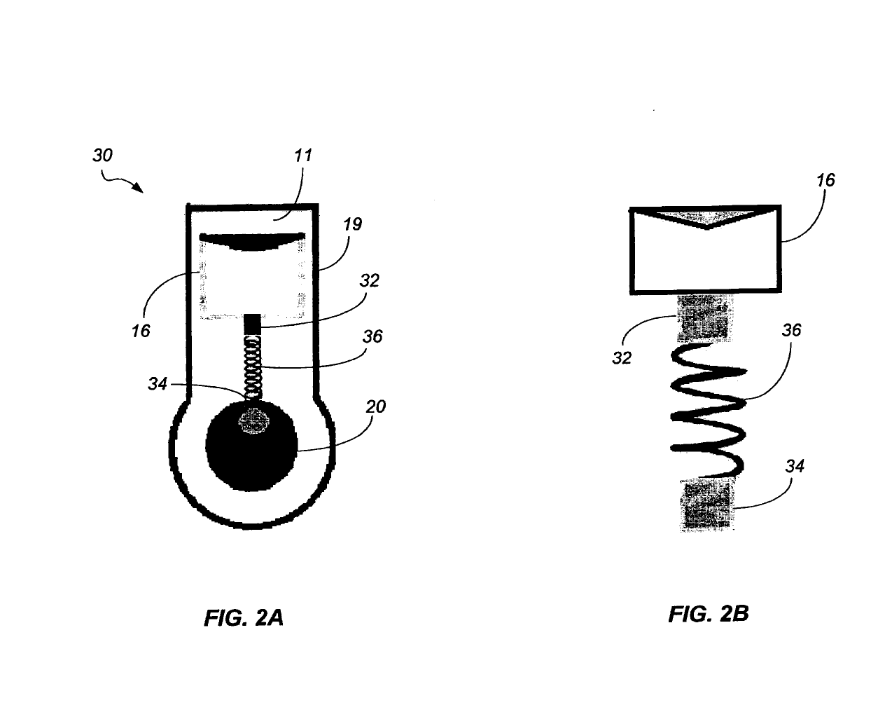

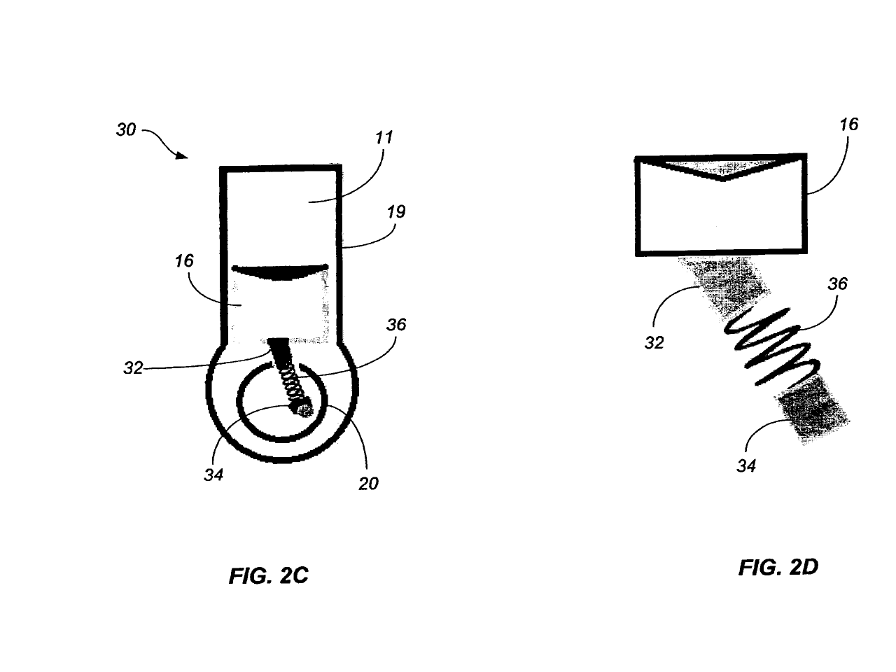

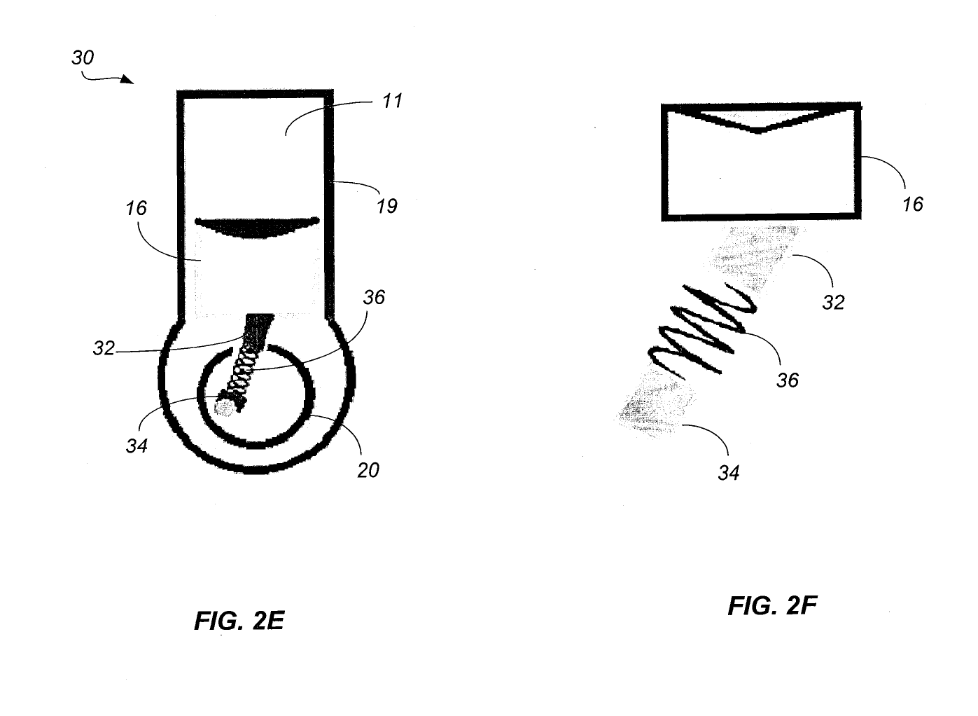

FIGS. 2A to 2F are schematic views of a spring loaded piston configuration in an internal combustion (IC) engine 10 according to a second embodiment of the disclosure. In FIG. 2A, piston cylinder assembly 30 may include a piston cylinder 19, a piston 16, a combustion chamber 11, a crankshaft 20, a first connecting rod portion 32, a second connecting rod portion 34, and a spring 36 disposed and connected between first connecting rod portion 32 and second connecting rod portion 34. In other words, spring 36 is within or part of the piston's connecting rod (32, 34). Spring 36 may be formed as a helical compression spring or the like. In FIG. 2A, the piston 16 is at or near top dead center (TDC) in a compression/exhaust stroke and spring 36 is not compressed, storing energy. FIG. 2B shows an enlarged view of the configuration of piston 16 of FIG. 2A at or near top dead center (TDC), the first connecting rod portion 32, the second connecting rod portion 34, and spring 36 in a relatively relaxed state. Connecting spring 36 may be formed as a spiral (helical) spring, or the like. In FIG. 2C, piston cylinder assembly 30 is shown in a power/intake stroke where connecting spring 36 is in a compressed position and stores energy as well as rotates crankshaft 20. FIG. 2D shows an enlarged view of the configuration of piston 16 of FIG. 2C at or near bottom dead center (BDC), with the first connecting rod portion 32, the second connecting rod portion 34 and connecting spring 36 in a compressed state.

In FIG. 2E, piston cylinder assembly 30 is shown at the beginning of a compression/exhaust stroke where spring 36 is beginning releasing its stored energy received in the power/intake stroke. FIG. 2F shows an enlarged view of the configuration of piston 16 of FIG. 2E. In other words, FIGS. 2A to 2F show the piston cylinder assembly 30 progressing through a 4-stroke cycle, for example, where connecting spring 36 is compressed in a stored energy state after combustion in the power stroke, and connecting spring 36 returns to a relatively relaxed state before combustion during the compression stroke. First connecting rod portion 32 may be pivotally connected to piston 16 in a conventional manner and second connecting rod portion 34 may be connected to crankshaft 20 in a conventional manner. Also, as discussed previously, a spring, such as connecting spring 36 may be connected to first connecting rod portion 32 and second connecting rod portion 34 by conventional means, such as connector bolts and/or welds.

The second embodiment shown in FIGS. 2A-F is similar in structure and operation to the first embodiment and has similar variations and applications except the energy storage connecting spring 36 connects between portions of the connecting rod (32, 34) instead of the top of piston 16 and a top portion of piston cylinder 19 and the base of piston 16 and a base portion of piston cylinder 19. It should be noted that piston cylinder 19 lacks a base portion in contrast to the first embodiment's piston cylinder 18 at 14. Connecting spring 36 is located in the fuel chamber 12 and is relatively relaxed or only slightly compressed or stretched when crankshaft 20 is at TDC (see FIG. 2A), and it stores energy by compressing; the most compressed condition exists when crankshaft 20 is at BDC. Further, since spring 60 is located on the axis of piston 16, that is, along the connecting rod (32, 34), only a single spring is needed.

Alternatively, piston cylinder 19 of the second embodiment shown in FIGS. 2A to 2F is similar in structure and operation to the first embodiment and has similar applications and variations except connecting rod 22 is replaced with connecting spring 36. Connecting spring 36, like connecting rods 32, 34 is rotably mounted to crankshaft 20 by conventional connectors, such as bolts. The purpose of using the connecting spring 36 instead of the connecting rod 22 of the first embodiment is to allow for more compression of energy than that of storage springs 26 and 28 during heavy loads because during heavy loads much more fuel burns and pushes down on piston 16 significantly harder during the power stroke. As a result, connecting spring 36 compresses and allows piston 16 to move closer to crankshaft 20 than if a connecting rod 22 were used, and thus, energy storage of connecting spring 36 compresses more and stores more energy. Then, during the exhaust stroke, more energy is delivered to crankshaft 20 by the spring 36, and the energy delivery during the power and exhaust strokes is better balanced (as well as the energy deliver during the other two strokes in a four-stroke engine).

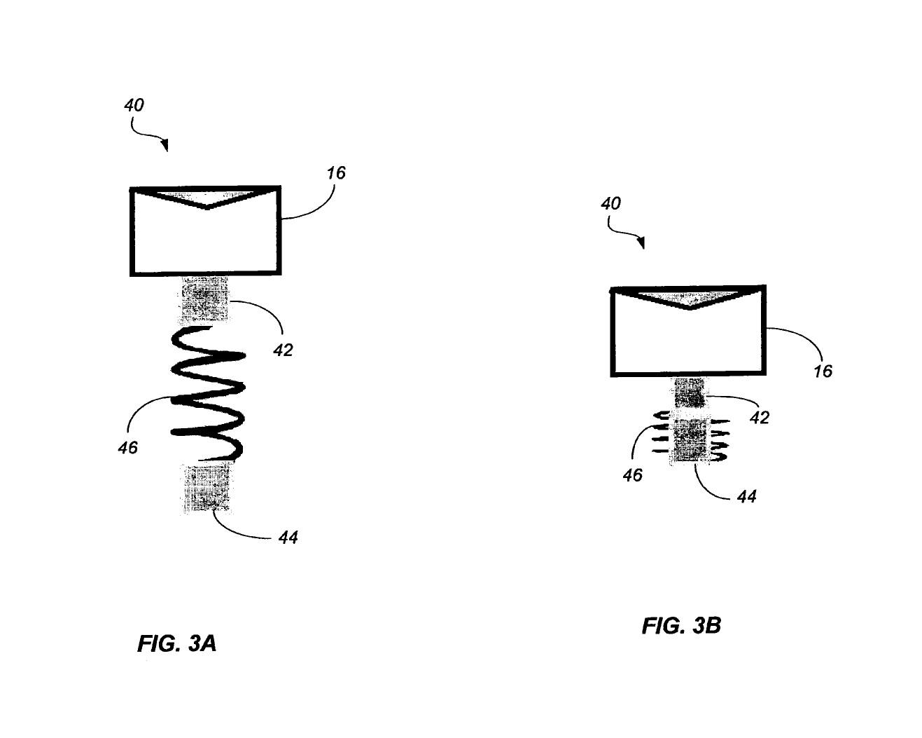

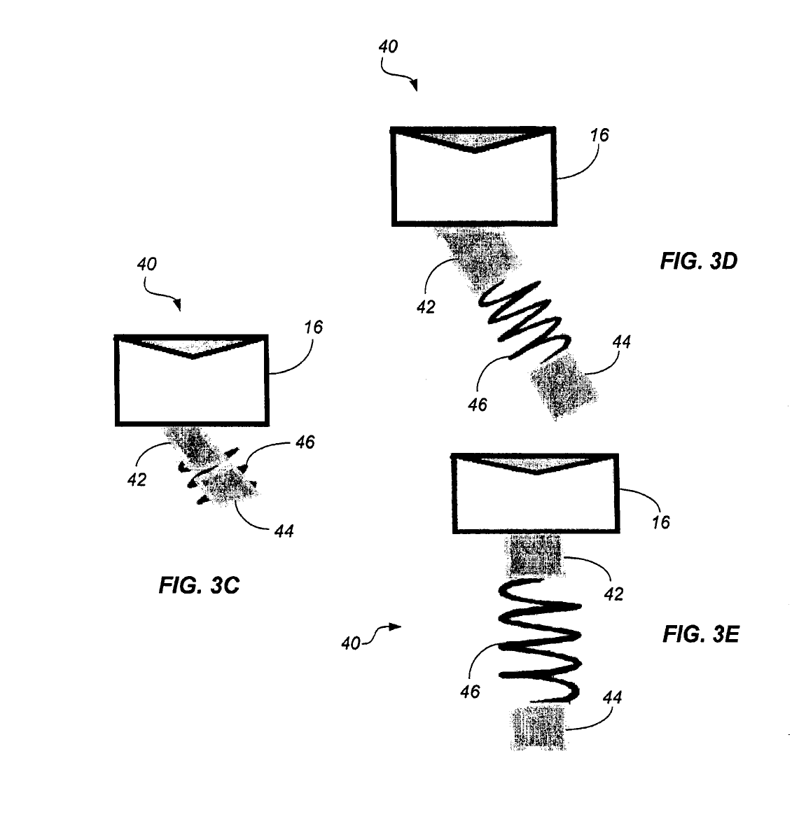

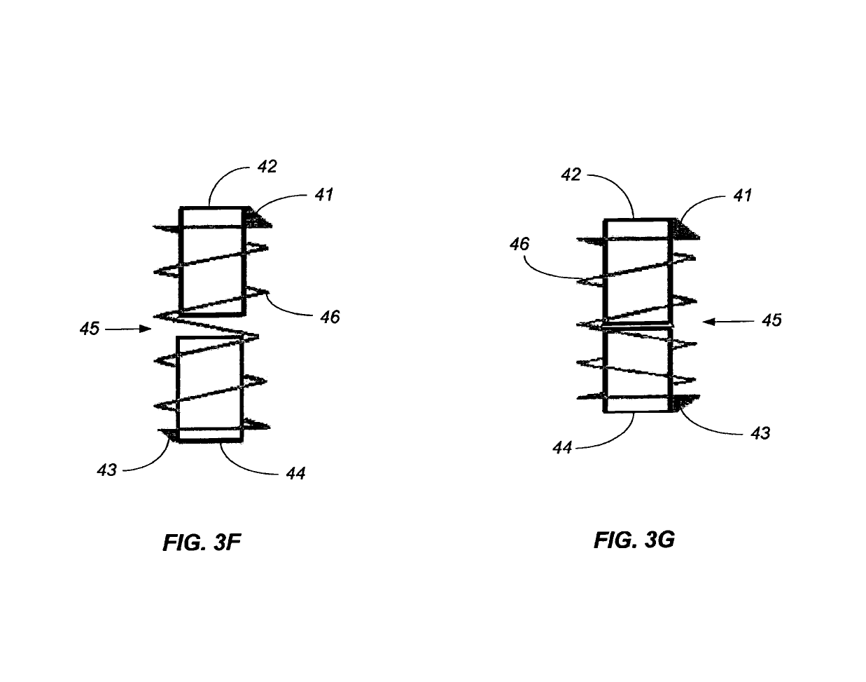

FIGS. 3A to 3G are schematic views of a spring loaded piston configuration in an internal combustion (IC) engine 10 according to a third embodiment of the disclosure. In FIG. 3A, piston assembly 40 is configured with a piston 16, a first connecting rod portion 42 and a second connecting rod portion 44, where a spiral spring (helical) 46 is disposed and connected between the first connecting rod portion 42 and the second connecting rod portion 44 at, for example, first connecting joint 41and at second connecting joint 43, respectively (see FIGS. 3F and 3G) in this embodiment. First connecting rod portion 42 is configured to act as a hammer while second connecting rod portion 44 is configured to act as an anvil in the hammer-anvil configuration of the third embodiment. Thus, when the hammer strikes the anvil during, for example, the power/intake stroke, energy is transferred to the crankshaft 20 while energy is stored in the spring 46 to be released during the compression/exhaust stroke. FIG. 3A shows piston assembly 40 with the first connecting rod portion 42 and the second connecting rod portion 44 spaced apart (see FIG. 3F at 45) when the piston 16 is after the fuel injection cycle of the engine, that is the compression/exhaust stroke with the spring 46 in an energy release state or uncompressed. FIG. 3B shows piston assembly 40 with the first connecting rod portion 42 (hammer) in contact with the second connecting rod portion 44 (anvil) when the piston 16 is after combustion or fuel explosion and in a power/intake stroke with the spring 46 in an energy storage state or compressed. FIG. 3C shows piston assembly 40 in the state where spring 46 begins to release its stored energy as piston 16 proceeds to a compression/exhaust stroke as depicted in both FIGS. 3D and 3E. FIG. 3E shows piston assembly 40 with piston 16 and connecting rod (42, 44) at a TDC position where spring 46 is in a released energy state.

In other words, FIGS. 3A to 3E show piston assembly 40 having the configuration of a hammer (42) and an anvil (44) may be applied by when fuel combusts, the explosive force from the fuel combustion causes the first connecting rod portion 42 (hammer) to percuss or strike the second connecting rod portion 44 (anvil) to effectively move the crankshaft (not shown). In FIG. 3D, as the power cycle progresses to the compression/exhaust stroke of the piston 16, the energy of spring 46 is released, thereby separating the first connecting rod portion 42 from the second connecting rod portion 44 and assisting in the upward movement of piston 16 to repeat the power/intake stroke (fuel injection cycle).

FIG. 3F shows an enlarged view of the first connecting rod portion 42 (hammer) and the second connecting rod portion 44 (anvil) in an energy released state with spring 46 relatively relaxed and a gap 45 opened between rod portion 42 and rod portion 44. In FIG. 3F, spring 46 is connected to rod portion 42 and rod portion 44 by first connecting joint 41 and second connecting joint 43, respectively. First connecting joint 41 and second connecting joint 41 may be conventional welds or the like to secure spring 46 accordingly.

FIG. 3G shows an enlarged view of the first connecting rod portion 42 (hammer) and the second connecting rod portion 44 (anvil) in an energy storage state with spring 46 compressed and the gap 45 closed between rod portion 42 and rod portion 44.

Piston assembly 40 of the third embodiment is shown in FIGS. 3A to 3G, and is similar in structure and operation to the second embodiment and has similar applications and variations except the storage spring 46 fits over connecting rods, 42, 44. The diameter of spring 46 must be large enough so that connecting rods 42, 44 can move back and forth freely within spring 46 and the opening to the crankshaft (not shown). Since spring 46 is disposed along the axis of piston 16, no other balancing spring is needed. Although, FIGS. 3A to 3G show only a single piston assembly 40, a plurality of similar assemblies may be used based on the engine configuration, that is, two-cylinder, four-cylinder, etc.

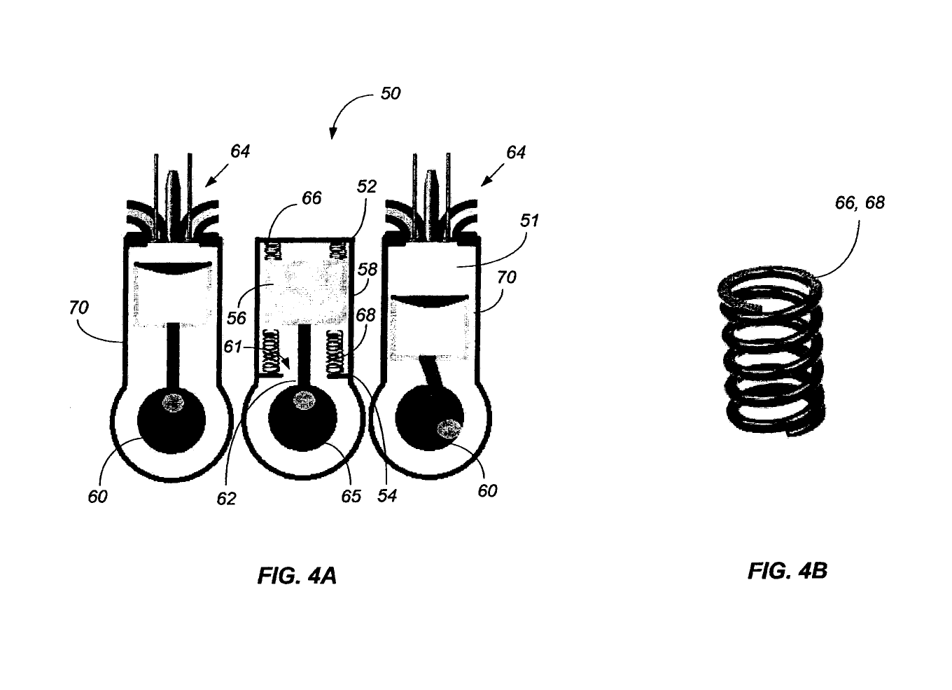

FIGS. 4A and 4B are schematic views of a spring loaded piston configuration in an internal combustion (IC) engine 50 according to a fourth embodiment of the disclosure. In FIG. 4A, IC engine 50 includes a configuration in which at least one dedicated independent piston cylinder 58 applies the principle of energy inherent in a first set of springs 66 and a second set of springs 68 configured similarly as in the first embodiment described above, however, there is no internal combustion occurring within piston cylinder 58. In FIG. 4A, piston cylinders 70 are configured for the internal combustion process to occur in the conventional manner via intake/exhaust valves 64 powering crankshafts 60. The piston cylinder 58 configuration includes a piston 56, a top portion 52, a base portion 54, a connecting rod opening 61, a crankshaft 65 and a connecting rod 62 configured similarly as in the first embodiment described above. In this embodiment, the energy stored and then released by sets of springs 66, 68 assists in moving crankshaft 65 and in turn powering the engine load without the direct need of internal combustion. FIG. 4B shows one of the spiral springs (helical) 66, 68 present in piston cylinder 58 of FIG. 4A configured as a coiled compression spring or the like.

Alternatively, a combination of the above discussed first, second, or third embodiments may be configured, for example, to include a dedicated independent cylinder 58, a spring loaded connecting rod (32, 34, 36), a spring loaded piston 16 having top and base attached springs (26, 28), and/or a hammer and an anvil configuration (42, 44, 46) to provide a more efficient IC engine.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology such that no inventive subject matter is dedicated to the public.

The above disclosure also encompasses the embodiments noted below.

(1) An internal combustion engine, comprising: at least one piston cylinder having a top portion and a base portion; at least one valve configured to introduce fuel into the at least one piston cylinder; at least one fuel igniter configured to ignite the introduced fuel; at leave one valve configured to exhaust burnt gases from the at least one piston cylinder; a piston disposed within the at least one piston cylinder; a crankshaft coupled to the piston via a connecting rod, wherein the connecting rod is pivotally connected to the piston and the crankshaft; and a first one or more springs configured to store energy received from the at least one piston and burnt gases during the power/intake stroke of the at least one piston, and to deliver a portion of the stored energy to the crankshaft during the compression/exhaust stroke of the at least one piston to drive the crankshaft in its existing direction of rotation.

(2) The internal combustion engine according to (1), further comprising: a second one or more springs configured to store energy received from the at least one piston during the compression/exhaust stroke of the at least one piston, and to deliver a portion of the stored energy to the crankshaft during the power/intake stroke of the at least one piston to drive the crankshaft in its existing direction of rotation.

(3) The internal combustion engine according to (1) or (2), wherein the first one or more springs includes a first set of springs and the second one or more springs includes a second set of springs.

(4) The internal combustion engine according to (1) to (3), wherein each set of springs includes a pair of springs.

(5) The internal combustion engine according to (1) to (4), wherein each set of springs is configured to have a predetermined stiffness.

(6) The internal combustion engine according to claim (1) to (5), wherein the predetermined stiffness is determined to be sufficient to store and partially drive the crankshaft upon each set of springs releasing their stored energy in a combustion cycle of the internal combustion engine.

(7) The internal combustion engine according to (1) to (6), wherein the first set of springs connect between the at least one piston and the base portion of the at least one piston cylinder, where the base portion is disposed proximal the crankshaft, and wherein the second set of springs connect between the at least one piston and the top portion of the at least one piston cylinder, where the top portion is disposed proximal the at least one valve.

(8) The internal combustion engine according to (1) to (7), wherein the first one or more springs include a spring disposed within the connecting rod, where the connecting rod has a first connecting rod portion and a second connecting rod portion.

(9) The internal combustion engine according to (1) to (8), wherein the spring is attached at one end to the first connecting rod portion and the spring is attached at another end to the second connecting rod portion.

(10) The internal combustion engine according to (1) to (9), wherein the first one or more springs include a spring disposed around the connecting rod, where the connecting rod has a first connecting rod portion and a second connecting rod portion.

(11) The internal combustion engine according to (1) to (10), wherein the spring is disposed around and attached to the first and the second connecting rod portions, wherein when combustion occurs during the power stroke, the piston is configured to push the first connecting rod portion towards the crankshaft and in turn percuss the second connecting rod portion during each power stroke.

(12) The internal combustion engine according to (1) to (11), wherein the first one or more springs is a helical compression spring.

(13) The internal combustion engine according to (1) to (12), wherein the second one or more springs is disposed in a combustion chamber of the at least one piston cylinder.

(14) An internal combustion engine, comprising: at least one piston cylinder including at least one valve configured to introduce fuel into the at least one piston cylinder; at least one fuel igniter configured to ignite the introduced fuel, and at leave one valve configured to exhaust burnt gases from the at least one piston cylinder, a first piston disposed within the at least one piston cylinder, and a first crankshaft coupled to the first piston via a first connecting rod, wherein the first connecting rod is pivotally connected to the first piston and the first crankshaft; at least one dedicated independent piston cylinder having a top portion and a base portion, wherein the at least one dedicated independent piston cylinder is configured such that no internal combustion occurs therein; a second piston disposed within the at least one dedicated independent piston cylinder, where the second piston is coupled to a second crankshaft via a second connecting rod, wherein the second connecting rod is pivotally connected to the second piston and the second crankshaft; and a first one or more springs configured to store energy received from the second piston during the outward movement of the second piston, and to deliver a portion of the stored energy to the second crankshaft during the inward movement of the second piston to drive the second crankshaft in its existing direction of rotation.

(15) The internal combustion engine according to (14), further comprising a second one or more springs configured to store energy received from the second piston during the inward movement of the second piston, and to deliver a portion of the stored energy to the second crankshaft during the outward movement of the second piston to drive the second crankshaft in its existing direction of rotation.

(16) The internal combustion engine according to (14) or (15), wherein the first one or more springs include a first set of springs and the second one or more springs include a second set of springs.

(17) The internal combustion engine according to (14) to (16), wherein the first set of springs are attached to the second piston and the base portion of the at least one dedicated independent piston cylinder, where the base portion is disposed proximal the second crankshaft, and wherein the second set of springs are attached to the second piston and the top portion of the at least one dedicated independent piston cylinder.

(18) The internal combustion engine according to (14) to (17), wherein each set of springs includes a pair of springs.

(19) The internal combustion engine according to (14) to (18), wherein the at least a pair of springs are disposed on opposite sides of the second connecting rod.

(20) An internal combustion engine, comprising: means for housing at least one piston, where the means for housing includes means for introducing fuel into the means for containing, means for igniting the introduced fuel, and means for exhausting the burnt gases, means for reciprocating the at least one piston; a first resilient means for storing energy received from the at least one piston during the outward movement of the at least one piston, and for delivering a portion of the stored energy to the means for reciprocating during the inward movement of the at least one piston to drive the means for reciprocating in its existing direction of rotation; and a second resilient means for storing energy received from the at least one piston and burnt gases during the power/intake stroke of the at least one piston, and for delivering a portion of the stored energy to the means for reciprocating during the compression/exhaust stroke of the at least one piston to drive the means for reciprocating in its existing direction of rotation.

1. An internal combustion engine, comprising:
at least one piston cylinder having a top portion and a base portion;
at least one valve configured to introduce fuel into the at least one piston cylinder;
at least one fuel igniter configured to ignite the introduced fuel;
at leave one valve configured to exhaust burnt gases from the at least one piston cylinder;
a piston disposed within the at least one piston cylinder;
a crankshaft coupled to the piston via a connecting rod, wherein the connecting rod is pivotally connected to the piston and the crankshaft; and
a first one or more springs configured to store energy received from the at least one piston and burnt gases during the power/intake stroke of the at least one piston, and to deliver a portion of the stored energy to the crankshaft during the compression/exhaust stroke of the at least one piston to drive the crankshaft in its existing direction of rotation.

2. The internal combustion engine according to claim 1, further comprising:
a second one or more springs configured to store energy received from the at least one piston during the compression/exhaust stroke of the at least one piston, and to deliver a portion of the stored energy to the crankshaft during the power/intake stroke of the at least one piston to drive the crankshaft in its existing direction of rotation.

3. The internal combustion engine according to claim 2, wherein the first one or more springs include a first set of springs and the second one or more springs includes a second set of springs.

4. The internal combustion engine according to claim 3, wherein each set of springs includes a pair of springs.

5. The internal combustion engine according to claim 4, wherein each set of springs is configured to have a predetermined stiffness.

6. The internal combustion engine according to claim 5, wherein the predetermined stiffness is determined to be sufficient to store and partially drive the crankshaft upon each set of springs releasing their stored energy in a combustion cycle of the internal combustion engine.

7. The internal combustion engine according to claim 3, wherein the first set of springs connect between the at least one piston and the base portion of the at least one piston cylinder, where the base portion is disposed proximal the crankshaft, and
wherein the second set of springs connect between the at least one piston and the top portion of the at least one piston cylinder, where the top portion is disposed proximal the at least one valve.

8. The internal combustion engine according to claim 1, wherein the first one or more springs include a spring disposed within the connecting rod, where the connecting rod has a first connecting rod portion and a second connecting rod portion.

9. The internal combustion engine according to claim 8, wherein the spring is attached at one end to the first connecting rod portion and the spring is attached at another end to the second connecting rod portion.

10. The internal combustion engine according to claim 1, wherein the first one or more springs include a spring disposed around the connecting rod, where the connecting rod has a first connecting rod portion and a second connecting rod portion.

11. The internal combustion engine according to claim 10, wherein the spring is disposed around and attached to the first and the second connecting rod portions, wherein when combustion occurs during the power stroke, the piston is configured to push the first connecting rod portion towards the crankshaft and in turn percuss the second connecting rod portion during each power stroke.

12. The internal combustion engine according to claim 1, wherein the first one or more springs is a helical compression spring.

13. The internal combustion engine according to claim 2, wherein the second one or more springs is disposed in a combustion chamber of the at least one piston cylinder.

14. An internal combustion engine, comprising:
at least one piston cylinder including
at least one valve configured to introduce fuel into the at least one piston cylinder;
at least one fuel igniter configured to ignite the introduced fuel, and
at leave one valve configured to exhaust burnt gases from the at least one piston cylinder,
a first piston disposed within the at least one piston cylinder, and
a first crankshaft coupled to the first piston via a first connecting rod, wherein the first connecting rod is pivotally connected to the first piston and the first crankshaft;
at least one dedicated independent piston cylinder having a top portion and a base portion, wherein the at least one dedicated independent piston cylinder is configured such that no internal combustion occurs therein;
a second piston disposed within the at least one dedicated independent piston cylinder, where the second piston is coupled to a second crankshaft via a second connecting rod, wherein the second connecting rod is pivotally connected to the second piston and the second crankshaft; and
a first one or more springs configured to store energy received from the second piston during the outward movement of the second piston, and to deliver a portion of the stored energy to the second crankshaft during the inward movement of the second piston to drive the second crankshaft in its existing direction of rotation.

15. The internal combustion engine according to claim 14, further comprising a second one or more springs configured to store energy received from the second piston during the inward movement of the second piston, and to deliver a portion of the stored energy to the second crankshaft during the outward movement of the second piston to drive the second crankshaft in its existing direction of rotation.

16. The internal combustion engine according to claim 14, wherein the first one or more springs include a first set of springs and the second one or more springs include a second set of springs.

17. The internal combustion engine according to claim 16, wherein the first set of springs are attached to the second piston and the base portion of the at least one dedicated independent piston cylinder, where the base portion is disposed proximal the second crankshaft, and
wherein the second set of springs are attached to the second piston and the top portion of the at least one dedicated independent piston cylinder.

18. The internal combustion engine according to claim 16, wherein each set of springs includes a pair of springs.

19. The internal combustion engine according to claim 18, wherein the at least a pair of springs are disposed on opposite sides of the second connecting rod.

20. An internal combustion engine, comprising:
means for housing at least one piston, where the means for housing includes
means for introducing fuel into the means for containing,
means for igniting the introduced fuel, and
means for exhausting the burnt gases,
means for reciprocating the at least one piston;
a first resilient means for storing energy received from the at least one piston during the outward movement of the at least one piston, and for delivering a portion of the stored energy to the means for reciprocating during the inward movement of the at least one piston to drive the means for reciprocating in its existing direction of rotation; and
a second resilient means for storing energy received from the at least one piston and burnt gases during the power/intake stroke of the at least one piston, and for delivering a portion of the stored energy to the means for reciprocating during the compression/exhaust stroke of the at least one piston to drive the means for reciprocating in its existing direction of rotation.
